(19) United States
(12) Patent Application Publication
(10) Pub. No.: US 2022/0348400 A1
(43) Pub. Date: Nov. 3, 2022

(54) GAS TURBINE ENGINE STORAGE AND TRANSPORT CONTAINER

(71) Applicant: VIETTEL GROUP, Ha Noi City (VN)

(72) Inventors: NGOC DUNG PHAM, Hung Ha District (VN); DUY HAI TRAN, Giao Thuy District (VN); TUAN ANH NGUYEN, Ha Noi City (VN); VAN NAM NGUYEN, Ha Noi City (VN); NHU VU HOANG, Ha Noi City (VN); HUY HOANG NGUYEN, Ha Noi City (VN)

(73) Assignee: VIETTEL GROUP, Ha Noi City (VN)

(21) Appl. No.: 17/727,146

(22) Filed: Apr. 22, 2022

(30) Foreign Application Priority Data
Apr. 29, 2021 (VN) 1-2021-02427

(51) Int. Cl. B65D 85/68; F02C 7/00; B65D 81/26; B65D 88/06; B65D 90/00; B65D 90/48; B65D 90/20; B65D 21/02

(52) U.S. Cl. CPC B65D 85/68; F02C 7/00; B65D 81/266; B65D 88/06; B65D 90/006; B65D 90/0073; B65D 90/48; B65D 90/008; B65D 90/20; B65D 21/0215; F05D 2260/02; B65D 2585/6877

(57) ABSTRACT

A gas turbine storage container is composed of a horizontal cylindrical shell with openings at two opposite ends of the cylinder, outside is designed with frames to keep it fixed and has straps to install ropes when hoisting. The inside of the cylindrical shell is pumped with inert gas and contains desiccant. The engine is housed in a mount that can be fixed to the inside of the box, and has wheels to make it possible to move it out of the box. A sensor system that measures the temperature and humidity status inside the cylindrical shell can provide information about the quality of the gas stored in the cylindrical shell in real time without opening.

### FIELD OF THE INVENTION

This invention refers to the field of gas turbine engines. Specifically, it proposes a special storage and shipping container for gas turbine engines. However, the scope of use of this can be extended for the storage and transport of the other equipments that have strict requirements on storage and transportation conditions.

### DESCRIPTION OF THE RELATED ART

Gas turbine engines are an important component in the aerospace industry. They have the role of providing propulsion, electricity and compressed air for aircraft vehicles. They have a high price and the cost for operating and maintenance is also expensive. Therefore, it is important to ensure that the engine is always in good condition, regardless of the conditions of transportation or storage. In the published patent documents, there are a number of works related to gas turbine engine storage tanks. Some of them can be reviewed as follows:

U.S. Pat. No. 4,117,927 dated Aug. 3, 1978 of the United States of America for a gas turbine engine container. In the content of the invention, the author presents a container of the aforesaid type which is easily manufactured, readily adapted for handling by standard freight handling equipment, strong enough to withstand the hazards of shipping and handling, adapted for stacking in stacks of three or more. Inside the container, there are tools for removing and replacing the engine. The container includes a lower fixed part and a separable upper part which can be removed to open the container. The upper part may then be lifted by the overhead crane at the eye bolts and placed on the lower part whereupon the bolts are tightened until two flanges meet, compressing the gasket to make an air-tight seal. With such a structure, when using the overhead crane to lift the container, bolts and nuts will be subjected to a great tension force which can cause deformation or destruction. The tightness of the container can also be reduced. The container is also not equipped with the monitoring system for controlling storage parameters. The system will help the operator promptly recognize to handle problems during the storage progress.

In another example, the U.S. Pat. No. 2,674,371 presents a shipping and storage container for jet-type engines. Specifically, the author describes about a container of the aforesaid type which is easily manufactured. The container comprises a cylindrical tank-like structure and a removable front lid portion that respectively provided with two mating flanges. A resilient gasket is provided for sealing the joint between the flanges against entry of air and moisture and the fastening bolts are adapted to be tightened to provide metal to metal contact of the flangers. However, the front eye bolts are on the lid that may lead to damage of the bolts and the gasket as well as affecting the tightness of the container when lifting container. In addition, a wireless sensors system to monitor the parameters of gas such as humidity, temperature and pressure need to be equipped to ensure tightness of container.

### SUMMARY OF THE INVENTION

The purpose of this invention is therefore to overcome the problems of the prior art by providing a gas turbine engine container with a monitoring wireless sensor system. Improvements in the mechanical design of this invention provide an improved storage quality for gas turbine engines, strong enough to withstand the hazards of transportation, adapted for stacking, easily getting the engine in and out the tank.

Concretely, the general object of this invention is to provide a gas turbine engine container which manufactured by steel, comprises a horizontal cylindrical tank and two lids with support frame on opposite side, cadmium plated to prevent corrosion and oxidation due to environmental influences during storage and transportation. The cylindrical tank of the container is supported in two rectangular cradles at both sides near each ends of the container in vertical alignment like a support frame which support the entire weight of the container and the engine inside. The upper side of the rectangular cradle is provided with ledges to stack in stacked configuration with other containers.

Another object of this invention is to provide a container of this type described, in which it is equipped with two sliding rails on the inside of the container. The engine is mounted on the rack with wheels, the rack with engine is placed and can be easily moved on these sliding rails in case of necessity.

A further object of this invention is the provision of a container capable of re-use.

In an alternative embodiment, this invention relates to a gas turbine engine, in which on each lid is equipped backflow valves for nitrogen intake and exhaust. In addition, on each lid is also equipped a monitoring wireless sensor system with the function of monitoring gas pressure, humidity and temperature. This system allows to monitor remotely these parameters.

### BRIEF DESCRIPTION OF THE DRAWINGS

The above and other objects and advantages of the invention will be more apparent from the following description and drawings, in which:

FIG. 1 is a side view of the gas turbine engine storage and transport container in accordance with the present invention;

FIG. 2 is a vertical view from the front of the gas turbine engine storage and transport container;

FIG. 3 is a vertical view from the rear of the gas turbine engine storage and transport container;

FIG. 4 is a top view of the gas turbine engine storage and transport container;

FIG. 5 is the section along line A-A of FIG. 3; and

FIG. 6 is a scheme of wireless sensor monitoring system of gas turbine engine storage and transport container.

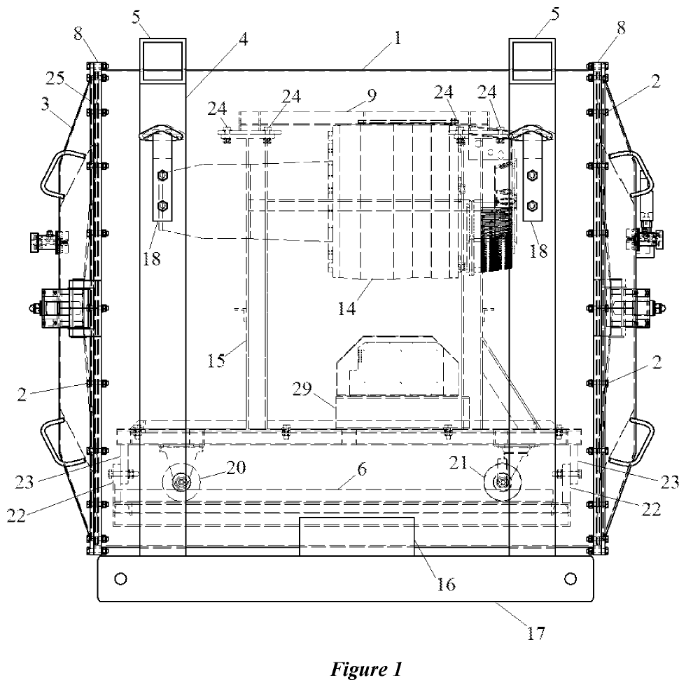

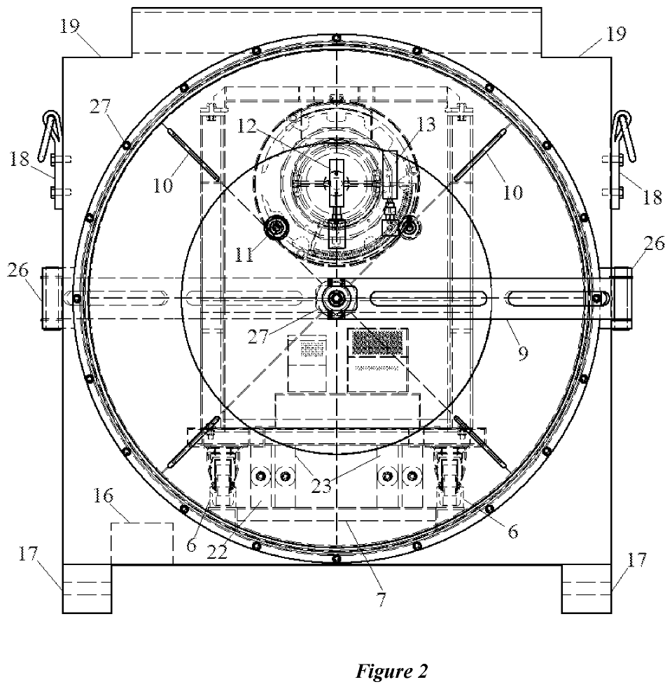

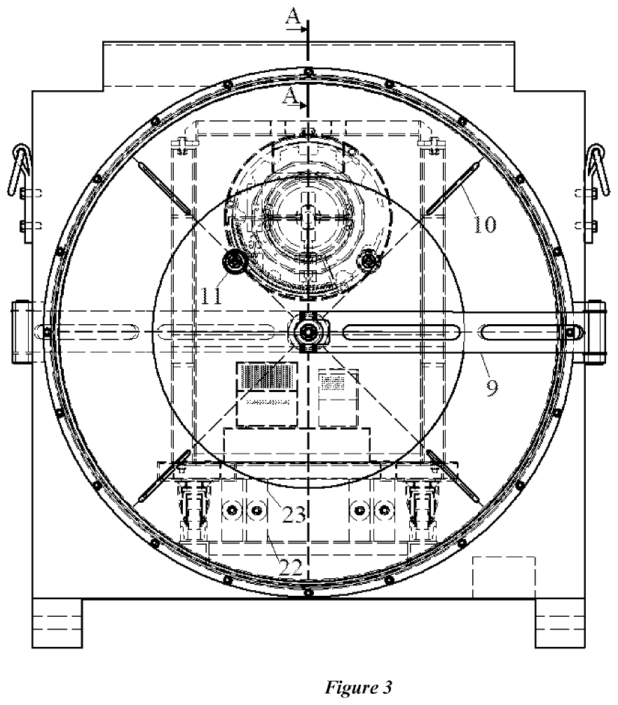

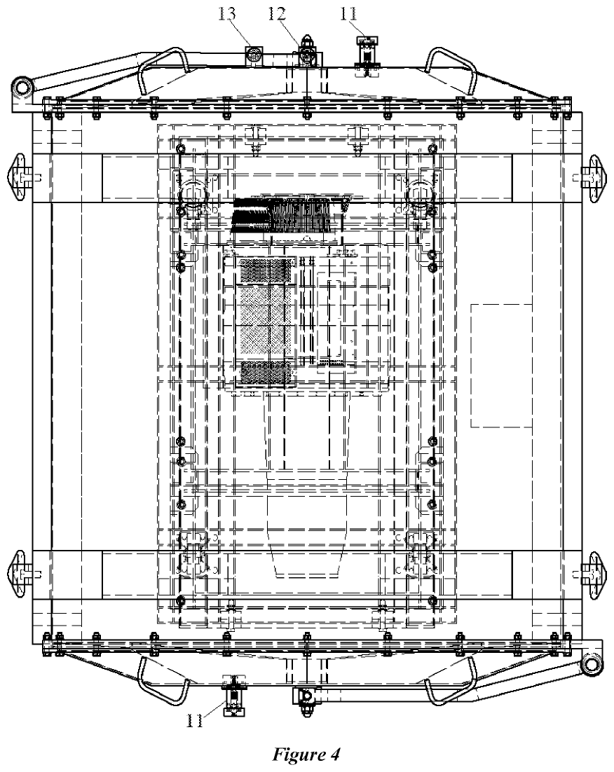

### DETAILED DESCRIPTION OF THE PREFERRED EMBODIMENTS

The Gas turbine engine storage and transport container proposed by this invention will now be explained in details. The gas turbine engine storage and transport container comprises the following components:

Cylindrical case 1 acts as the protective frame and supports all the components inside the container. At the two edges of case 1, two thick flanges 8 are welded to prevent warping when tightening bolts and nuts. Inside the case 1 is arranged a rail assembly consisting of two longitudinal rails welded above the steel square bar on both sides that act as a rolling track for the fixed wheel 20 of the rack truck and two rails 7 to ensure the stability of the rail assembly.

On the front lid, there is a non-return valve 11 with air filling function for sealing check and preservation. A device with integrated temperature and humidity sensor 13 connected to a transmitter 12 is mounted on the mounting plate by means of a threaded connection. The back lid has a release valve 11 that has the function of venting the gas in the cylindrical tank to the environment to ensure safety before opening the lid. On the two lids of the tank, there is a warning to push the release valve button to lower the pressure in the tank before opening.

Two support frames 4 are welded to the case 1 to act as the main support for an equipment box. In the upper part of the support frame 4, there is a fixing bar 5 and a slot 19 for placing and securing the container when stacking. The two sides of the support frame 4 are arranged with hanging straps 18 for working with the crane. In the lower part of the support frame 4, there is a stand for the engine container 17, which is spaced just enough to allow the forklift to be used during transport and to reduce contact with the ground.

Above the engine rack 6 is the engine mount 9, which is designed to be able to hang different types of engines. The moveable rack can be held in place by the fixing pins 23 at the four corners. At the positions where the engine is attached to the mount, elastic cushions are arranged. Underneath the engine rack 6 are four wheels whose stiffness and elasticity are within a pre-estimated range. In which, two fixed wheels 20 have a fixed axis and two navigation wheels 21 can rotate freely to facilitate movement and navigation. The accessory blocks attached to the engine are fixed at the engine stand 6. The engine moveable rack 6 and the rail assembly are fixed together by fixing pins 22, 23 by bolts and nuts. Thanks to such constructions, the storage bin has shock-absorbing elements, thereby minimizing shocks and vibrations during transport.

Two support frames 4 are welded to the cylinder body and act as the main support frame for the container. In the upper part of the frame there is a fixed rod 5 and a slot 19 for placing and fixing the container when stacking, and the two sides of the support frame are arranged with four hanging straps 18 for use with the crane. In the lower part of the frame there is a stand 17 with enough distance to be able to use the forklift during transportation. Equipment box 16 contains the mechanical tools for disassembling the engine and mounting brackets. Container lid opening and closing mechanism includes support arm 9 which can be freely rotated around the axis of hinge 26. The lid and support arm 9 are linked by the rotary knob 27 which can be rotated flexibly to adjust the lid position during the removal of fixed pins 22, 23. Two other side-welded 26 hinges are attached to the two flanges 8 of the case to ensure safety and balance the center of gravity in case the lids are opened on both sides.

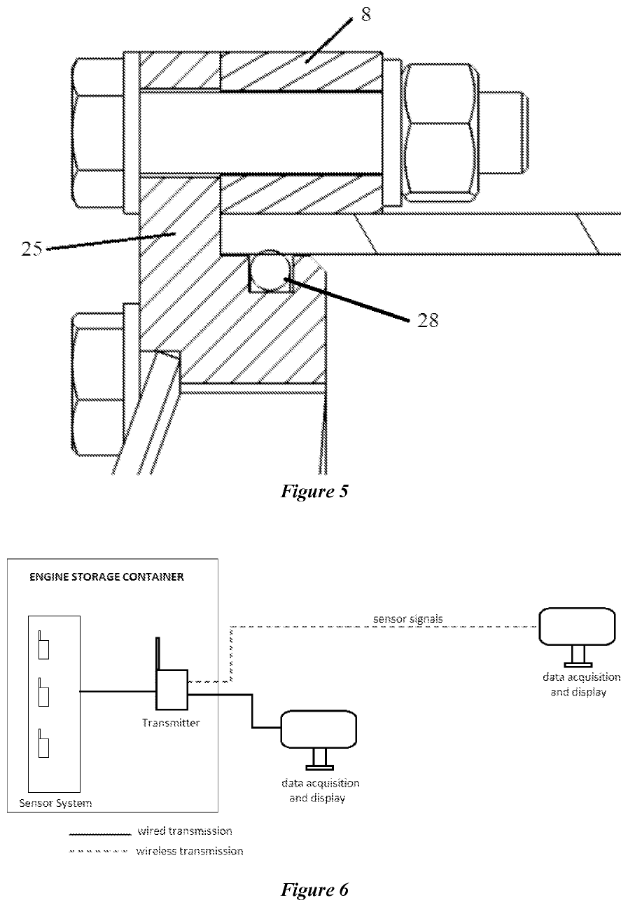

FIG. 5 shows the structure of the flange part of the tank lid 25, with grooves for placing rubber gaskets, combined with bolts and nuts that are tightened to seal. Referring to FIG. 6, the storage environment monitoring system comprises a pressure sensor, a temperature sensor, a humidity sensor and a transmitter device installed on the lid of each container. This system wirelessly transmits the storage status. A data acquisition device receives this signal remotely and displays it on a monitor screen at the storage facility.

With the mentioned structure, the process of using a gas turbine engine storage tank includes activities such as putting the engine in/out the tank, fixing the engine and movable rack, opening/closing the storage tank, pumping inert gas into the tank, set up sensors to monitor air quality in real time

To get the engine into the tank, the front lid is opened, the two floor rails are pulled out and hard objects is inserted underneath the rails. Next, the engine attached movable rack is placed on the rail by a crane or forklift, and then pushed into the tank. Two rails are pushed neatly into the tank. The process of taking the engine out of the tank is done in reverse.

The engine rack is fixed in the storage tank by means of the swivel feet and a fixed position by bolts and nuts to the rails in the box. This helps the engine and the vehicle to not collide with the box during transportation.

Before the tank lid is closed for long-term storage, bags of desiccant material are placed in the storage tank. The tools for disassembling the engine on the movable rack are placed in the tool box inside the tank. Then, the lids are pressed against the tank flange and rotated to adjust the screw position. All screws are tightened to hold the tank lid in place.

After closing the storage box, the sensor system to monitor the gas status in the container is set up. The system consists of a temperature sensor, a humidity sensor, a gas pressure sensor and a device that aggregates data and transmits wirelessly. A signal receiver is used and connected to a computer with software installed to display sensor data.

Inert gas is injected into the storage tank through a non return valve on the front lid. At the beginning of the injection, the release valve button on the back lid of the tank is pressed for about 2 minutes so that the air in the tank is pushed out. Observation is made on the software that displays the gas pressure in the tank until the pressure is raised to a proper value, then pumping inert gas is stopped.

Next, the tightness of the container is checked by monitoring the pressure drop after 24 hours. If the pressure drop is within the allowable range, the container is of good quality and ready to be transported or put into long-term storage. If the pressure drop exceeds the allowable limit, it is necessary to re-check the process of closing and sealing the tank.

When removing the engine from the container, to open the storage tank, first the gas in the tank is released by pressing the one-way valve vent button on the back lid of the tank until no more air is released. Then, all the bolts and screws on the flange that attaches the lids to the housing are unscrewed. Next, the handles on the lid are manually pulled to open the storage bin.

During transportation and storage, attention should be paid to placing the container in a dry place, with low humidity, less vibration and impact. When using a crane to lift the tank, attention should be paid to attach the hanging rope to the straps so that the box is kept balanced, not wobbly.

1. Storage tank for a gas turbine engine, comprising the following structure:
A horizontal cylindrical shell with support frames enclosing ribs, with two lids at ends of the cylindrical shell that can be opened and closed;
metal straps around the cylindrical shell to hook a crane's sling;
the inside of the barrel is pumped with an inert gas and has desiccant materials to ensure that the humidity is always low;
inside the barrel there is an engine moveable rack, a floor of the inside of the cylindrical shell has rails for the engine moveable rack to move on, avoiding collisions with the cylindrical shell;
an air status sensor system and transmitter provided on the lids of cylindrical shell to help monitor storage condition inside the cylindrical shell.

2. The storage tank for gas turbine engine according to claim 1, in which:
the horizontal cylindrical shell is machined from sheet metal, has two lids and two supports on opposite horizontal sides of the cylindrical shell, wherein the lids and cylindrical shell are plated and powder coated inside and outside to resist corrosion and oxidation.

3. The storage tank for gas turbine engine according to claim 1, in which:
inert gas is pumped to a positive pressure into the cylindrical shell through a non-return valve on a first of the tank lids; in a second opposite lid there is a release valve used to release air before opening; inside the cylindrical shell there are desiccant materials to ensure low humidity.

4. The storage tank for gas turbine engine according to claim 1, in which:
The two tank lids are designed with grooves to place rubber gaskets, combined with bolts and nuts to tighten to ensure tightness; prevent inert gas leakage inside the cylindrical shell; prevent water, air from entering the cylindrical shell which can reduce the quality of storage air.

5. The storage tank for gas turbine engine according to claim 4, in which:
metal flanges are welded to opposite sides of the cylindrical shell and on the lids of the cylindrical shell, each flange has holes for bolts and nuts.

6. The storage tank for gas turbine engine according to claim 1, in which:
metal flanges are welded to opposite sides of the cylindrical shell and on the lids of the cylindrical shell, each flange has holes for bolts and nuts.

7. The storage tank for gas turbine engine according to claim 1, in which:
a support arm for the lids of the cylindrical shell is composed of a metal bar that is connected to the lids through a knob at a first end of the bar and another end of the bar is attached to a hinge on the cylindrical shell; the rotary knob to make it easy to adjust a position of the lid during removal of bolts and nuts.

8. The storage tank for gas turbine engine according to claim 4, in which:
a support arm for the lids of the cylindrical shell is composed of a metal bar that is connected to the lids through a knob at a first end of the bar and another end of the bar is attached to a hinge on the cylindrical shell; the rotary knob to make it easy to adjust a position of the lid during removal of bolts and nuts.

9. The storage tank for gas turbine engine according to claim 1, in which:
the support frames around the side of the tank are designed with feet on lower sides below and a step on upper sides to allow stacking of storage tanks one to an other.

10. The storage tank for gas turbine engine according to claim 4, in which:
the support frames around the side of the tank are designed with feet on lower sides below and a step on upper sides to allow stacking of storage tanks one to an other.

11. The storage tank for gas turbine engine according to claim 1, in which:
the engine movable rack inside the cylindrical shell is designed to be movable on rails and on flat surfaces, and also has mechanisms to help fix the rack on a flat surface, and to be fixed when placed in the tank.

12. The storage tank for gas turbine engine according to claim 4, in which:
the engine movable rack inside the cylindrical shell is designed to be movable on rails and on flat surfaces, and also has mechanisms to help fix the rack on a flat surface, and to be fixed when placed in the tank.

13. The storage tank for gas turbine engine according to claim 1, in which:
the rails inside the tank consist of two rails that are fixed under the floor of the engine tank, with a part that can slide in and out.

14. The storage tank for gas turbine engine according to claim 13, in which:
the rails inside the tank consist of two rails that are fixed under the floor of the engine tank, with a part that can slide in and out.

15. The storage tank for gas turbine engine according to claim 1, in which:
the air status sensor system in the storage tank has pressure sensors, temperature sensors, humidity sensors and signal transmitters to help monitor the gas status in the storage tank without opening.
